(19) United States
(12) Patent Application Publication
(10) Pub. No.: US 2025/0147705 A1
(43) Pub. Date: May 8, 2025

(54) INFORMATION PROCESSING APPARATUS, CONTROL METHOD FOR THE SAME, AND STORAGE MEDIUM

(71) Applicant: CANON KABUSHIKI KAISHA, Tokyo (JP)

(72) Inventor: RYOYA KAWAI, Kanagawa (JP)

(21) Appl. No.: 18/930,312

(22) Filed: Oct. 29, 2024

(30) Foreign Application Priority Data
Nov. 2, 2023 (JP) 2023-188313

(51) Int. Cl. G06F 3/12

(52) U.S. Cl. CPC G06F 3/1256; G06F 3/1203; G06F 3/1224

(57) ABSTRACT

A method for an information processing apparatus that executes an application includes receiving selection of a function to be executed from among functions provided by the application from a user, and in a case where the selection of the function is received in a state where the application is not permitted to use a local area network (LAN), and in a case where the selected function is a function that uses the LAN, displaying a screen regarding permission to use the LAN.

### BACKGROUND

### Field

The present disclosure relates to an information processing apparatus, a control method for the information processing apparatus, and a storage medium.

### Description of the Related Art

A configuration is generally known in which data is transmitted to an external apparatus such as a printer using an application installed on an information processing apparatus such as a personal computer (PC) or a smartphone. An operating system (OS) that is basic software is installed on the information processing apparatus, and the application is called by the OS and operates. In this configuration, a technique is known in which in a case where the information processing apparatus can communicate with the external apparatus via a local area network (LAN), the information processing apparatus transmits data to the external apparatus preferentially using the LAN (Japanese Patent Application Laid-Open No. 2022-40993).

On the other hand, due to an increase in security consciousness in recent years, there is a case where an application is restricted from communicating via a LAN, and the application needs to be permitted to access the LAN by a user in order that the application can communicate with an external apparatus via the LAN. Moreover, environments where an information processing apparatus and an external apparatus are not permitted to communicate with each other via a LAN and environments where a LAN is not present (LAN-free environments) also increase. Thus, it is assumed that the application is used in a variety of environments. If the application uniformly requests the user to permit access to the LAN, usability may decrease.

### SUMMARY

In view of the above issue, the present disclosure is directed to providing a method capable of requesting a user to permit access to a local area network (LAN) without decreasing usability.

According to an aspect of the present disclosure, a method for an information processing apparatus that executes an application includes receiving selection of a function to be executed from among functions provided by the application from a user, and in a case where the selection of the function is received in a state where the application is not permitted to use a local area network (LAN), and in a case where the selected function is a function that uses the LAN, displaying a screen regarding permission to use the LAN.

Further features of the present disclosure will become apparent from the following description of exemplary embodiments with reference to the attached drawings.

### BRIEF DESCRIPTION OF THE DRAWINGS

FIG. 1 is a diagram illustrating an example of a printing system.

FIG. 2 is a diagram illustrating an example of a hardware configuration of a multifunction peripheral (MFP).

FIG. 3 is a diagram illustrating an example of a hardware configuration of a computer.

FIG. 4 is a diagram illustrating an example of a software configuration of an information processing apparatus.

FIG. 5 is a schematic diagram illustrating information regarding an MFP registered in a cloud print service (CPS).

FIGS. 6A to 6D are examples of screens displayed by an application.

FIG. 7 is an example of a screen displayed in a case where a state of permission to access a local area network (LAN) is a state where the application is not permitted to access the LAN.

FIG. 8 is an example of a “settings” screen displayed by an operating system (OS).

FIG. 9 is an example of a screen displayed in a case where the state of permission to access the LAN is a state where the application has not yet been permitted to access the LAN.

FIG. 10 is an example of a search screen for searching for a local MFP.

FIG. 11 is a flowchart illustrating an example of a search process for searching for a local MFP.

FIGS. 12A and 12B are examples of screens regarding printing using a local MFP.

FIG. 13 is a flowchart illustrating an example of a printing process using a local MFP.

FIGS. 14A to 14C are examples of screens regarding printing using a cloud MFP.

FIG. 15 is a flowchart illustrating an example of a printing process using a cloud MFP.

FIG. 16 is a flowchart illustrating an example of a search process for searching for a local MFP.

### DESCRIPTION OF THE EMBODIMENTS

Specific exemplary embodiments for carrying out the content of the present disclosure will be described below with reference to the drawings.

The following exemplary embodiments do not limit the disclosure according to the appended claims more than necessary, and not all the combinations of the features described in the exemplary embodiments are essential for a method for solving the issues in the present disclosure.

### Configuration of Printing System

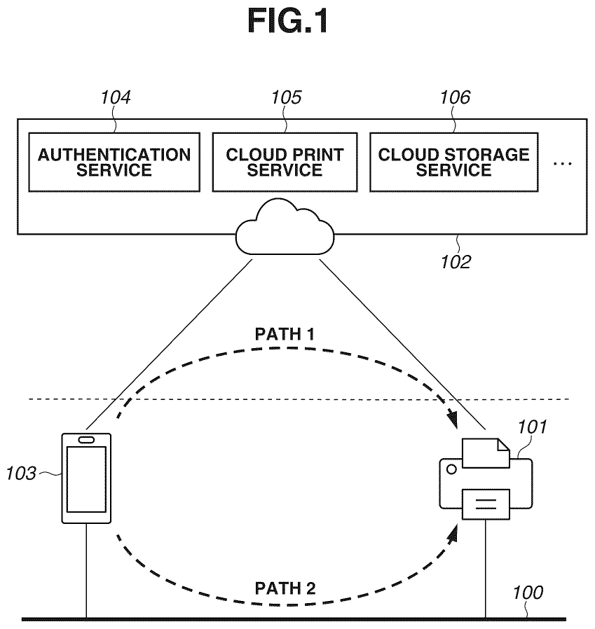

First, with reference to FIG. 1, the configuration of a printing system according to a first exemplary embodiment of the present disclosure is described. The printing system according to the present exemplary embodiment includes a multifunction peripheral (MFP) 101, a cloud platform 102 that provides an authentication service 104, a cloud print service (hereinafter “CPS”) 105, and a cloud storage service 106, and an information processing apparatus 103. In the present exemplary embodiment, it is assumed that a CPS is provided as a service on a cloud platform such as Amazon Web Services® (AWS), Azure®, or Google Cloud Platform™.

The information processing apparatus 103 can also belong to a local area network (hereinafter “LAN”) 100.

In the present exemplary embodiment, a case is assumed where the information processing apparatus 103 is a device that can be carried around, such as a laptop personal computer (PC), a tablet terminal, or a smartphone. The present disclosure, however, is not limited to this. The information processing apparatus 103 may be a smartwatch, smartglasses, or a virtual reality (VR) headset device.

There is also a case where the information processing apparatus 103 is connected to the LAN 100 of a company or an organization and used for work or activities in the comany or the organization. As the LAN 100 in this case, a wireless LAN based on Wi-Fi® is assumed. The LAN 100, however, may be a wired LAN. Communication via the LAN 100 may be communication based on Wi-Fi Direct® for achieving direct communication. There are also a case where the information processing apparatus 103 is connected to the LAN 100, but restricted from communicating via the LAN 100, and a case where the information processing apparatus 103 is not connected to the LAN 100 in the first place. In these cases, the information processing apparatus 103 is connected to a public wireless line or another network, but cannot directly communicate with the MFP 101 connected to an internal network where a firewall is provided in the company or the organization. Examples of the case where the information processing apparatus 103 is restricted from communicating via the LAN 100 include a case where the information processing apparatus 103 is not permitted to communicate via the LAN 100 by a user based on a setting of an operating system (OS) of the information processing apparatus 103, and a case where the information processing apparatus 103 is not permitted to communicate via the LAN 100 as a network setting. Examples of the case where the information processing apparatus 103 is not restricted from communicating via the LAN 100 include a case where the information processing apparatus 103 is permitted to communicate via the LAN 100 by the user, and a case where the information processing apparatus 103 is permitted to communicate via the LAN 100 as the network setting.

The MFP 101 communicates with the information processing apparatus 103 and the CPS 105 provided by the cloud platform 102 via a network. In the present exemplary embodiment, the state where the MFP 101 is registered as an output destination MFP under control of the CPS 105 is illustrated. Similarly to the information processing apparatus 103, there is also a case where the MFP 101 is connected to the LAN 100 and used for work or activities in the company or the organization. Similarly to the information processing apparatus 103, there are also a case where the MFP 101 is connected to the LAN 100, but restricted from communicating via the LAN 100, and a case where the MFP 101 is not connected to the LAN 100 in the first place. In these cases, the MFP 101 is connected to a public wireless line or another network, but cannot directly communicate with the information processing apparatus 103 connected to an internal network where a firewall is provided in the company or the organization. Examples of the case where the MFP 101 is restricted from communicating via the LAN 100 include a case where the information processing apparatus 103 is not permitted to communicate with the MFP 101 via the LAN 100 by the user, and a case where the MFP 101 is not permitted to communicate via the LAN 100 as a network setting.

Next, printing via the CPS 105 is described. By an operation on the information processing apparatus 103 by a user permitted to use the CPS 105, the CPS 105 sets the MFP 101 registered in the CPS 105 as an output destination MFP. If the setting of the output destination MFP is completed, desired print settings are made through a print settings screen. Next, based on a printing start instruction given by the user, the information processing apparatus 103 transmits a print job to the CPS 105. Based on the transferred print job, the MFP 101 executes printing. Also, in a case where the information processing apparatus 103 is restricted from communicating via the LAN 100 or a case where the information processing apparatus 103 is not connected to the LAN 100, the MFP 101 can perform printing via such a communication path using public communication indicated as a path 1 in FIG. 1.

Next, printing via the LAN 100 is described. In a case where the information processing apparatus 103 is connected to the LAN 100 and is not restricted from communicating via the LAN 100, the information processing apparatus 103 can communicate with the MFP 101 using a path 2 via the LAN 100. In a case where the information processing apparatus 103 is restricted from communicating via the LAN 100, or in a case where the information processing apparatus 103 is not connected to the LAN 100, the MFP 101 cannot perform printing using such a communication path indicated as the path 2.

As described above, the method for the information processing apparatus 103 to communicate with the MFP 101 uses two paths, namely the communication path via the CPS 105 indicated as the path 1 and the communication path via the LAN 100 indicated as the path 2. A print application installed on the information processing apparatus 103 is an application that can transmit a print job to the MFP 101 using the path 1 and can also transmit a print job to the MFP 101 using the path 2. The print application has a function capable of transmitting not only a print job but also a scanning execution instruction, an image forming instruction, and a control instruction using both the paths 1 and 2.

In a case where the print application installed on the information processing apparatus 103 is to communicate via the LAN 100, the print application may request permission from the user. That is, in a case where the print application is to communicate with the MFP 101 via the LAN 100, the print application requires permission from the user. If the print application receives an operation of indicating permission by the user, the print application can use a LAN function and communicate with the MFP 101. For example, in a case where the information processing apparatus 103 is iPhone® on which iOS® is mounted as the OS, or iPad® on which iPadOS® is mounted as the OS, the information processing apparatus 103 requires the user's permission to access the LAN 100. As described above, there is a case where as the specification of the OS of the information processing apparatus 103, in order for applications operating on the OS to use a LAN communication function, the user needs to permit each application to use the LAN communication function by operating a screen. If the state of the user's permission to access the LAN 100 is the state where the print application is not permitted to access the LAN 100, i.e., if the user does not perform an operation of permitting the print application to communicate with the LAN 100, the print application cannot communicate with the MFP 101 via the LAN 100. To enable the print application to communicate via the LAN 100, for example, it is also possible that a message indicating to the user that the print application is not permitted to access the LAN 100 is displayed when the print application starts, thereby urging the user to give permission. Then, the print application is maintained in the state where the print application cannot be used until the print application is permitted to access the LAN 100. The print application, however, can also communicate with the MFP 101 via the CPS 105, i.e., a public wireless line, without using the LAN 100. Thus, if a configuration is employed in which the message is uniformly displayed when the print application starts as described above, this is cumbersome to the user. Then, if a configuration is employed in which the print application is brought into the state where the print application cannot be used until the print application obtains the user's permission, an issue arises where the user cannot give an execution instruction to the MFP 101 via the CPS 105, either.

The present exemplary embodiment provides a mechanism for solving the issue that arises in the above environment. Specifically, the present exemplary embodiment provides a mechanism for enabling the print application installed on the information processing apparatus 103 to be suitably used even in an environment where the information processing apparatus 103 is not permitted to communicate with the MFP 101 via the LAN 100 by the user. The mechanism is specifically described below. A “local MFP” means an apparatus including a hardware resource that prints an image on a sheet (e.g., a print engine that prints an image on a sheet using a printing method such as an electrophotographic method or an inkjet method). An “output destination MFP” or a “cloud MFP” on the CPS 105 means a virtual MFP that is managed on the CPS 105 and transfers data to a local MFP registered in the CPS 105. Although a description is given using an MFP as an example, a single-function image forming apparatus such as a printer or a scanner may be used.

The MFP 101 has a scan function for transmitting data based on an image obtained by reading a document using a scanner to outside, a print function for printing an image on a sheet such as paper based on a print job received from an external apparatus, and a copy function. The MFP 101 can also receive a print job via the CPS 105 and perform printing. Although in the present exemplary embodiment, an MFP having a plurality of functions is illustrated as an example of a printing apparatus, the present disclosure is not limited to this. For example, the printing apparatus may be a single-function image forming apparatus having only a print function, or may be an image forming apparatus having only a scanner function. Alternatively, the printing apparatus may be a print server that transfers received print data to an MFP under control of the print server. The present exemplary embodiment can also be applied to any other apparatus, such as a camera, a television, or a music player, capable of communicating with the information processing apparatus 103 via the LAN 100 and the cloud platform 102

A network for performing communication using the path 1 via the CPS 105 may be configured by combining a communication network such as a LAN or a wide area network (WAN), a cellular network (e.g., Long-Term Evolution (LTE) or fifth generation (5G)), and a wireless network compliant with the Institute of Electrical and Electronics Engineers (IEEE) 802.11. That is, the network for performing communication using the path 1 only needs to be configured to enable the transmission and reception of data, and may employ any method as a method for communication between physical layers.

Next, the cloud services provided to a customer by the cloud platform 102 are described. The cloud platform 102 is a service platform that provides the CPS 105, the cloud storage service 106, a web email service, and a service for creating and editing a document to an organization such as a company. The cloud platform 102 does not need to provide all these cloud services, and may provide only some of the cloud services. The cloud platform 102 also includes the authentication service 104 for authenticating and managing a user or a device that uses the various services.

The authentication service 104 authenticates and manages a device with respect to each user. The cloud platform 102 manages authority to use the cloud services and manages access to customer data with respect to each user. A cloud MFP registered in the CPS 105 is also managed with respect to each user. A tenant can also be provided as the use unit of the cloud platform 102. Specifically, in a case where the cloud platform 102 performs management on a tenant-by-tenant basis, a different tenant is assigned to each organization (e.g., each company or each organization) having a contract to use the cloud platform 102. In this case, user data including print data, data required to achieve the CPS 105, and a user database (DB) for user authentication is managed with respect to each tenant.

A cloud MFP is a software module that provides the function of temporarily holding a print job received from outside, and the function of transferring the held print job to a print control apparatus such as a local MFP at a subsequent stage.

The CPS 105 receives a print job from a print client such as the information processing apparatus 103 and transmits the print job to a corresponding cloud MFP. The cloud MFP stores the print job in a holding area managed by the cloud MFP. Next, the cloud MFP notifies the MFP 101 registered in the CPS 105 that a print job is submitted. The MFP 101 having received the notification acquires the print job from the holding area of the cloud MFP and executes printing based on the acquired print job.

The information processing apparatus 103 includes a print application that is a print client for performing printing via the CPS 105. The print application mounted on the information processing apparatus 103 also has the function of directly transmitting print data to a local MFP via the LAN 100 and causing the local MFP to perform printing. The details will be described below.

### Configuration of MFP 101

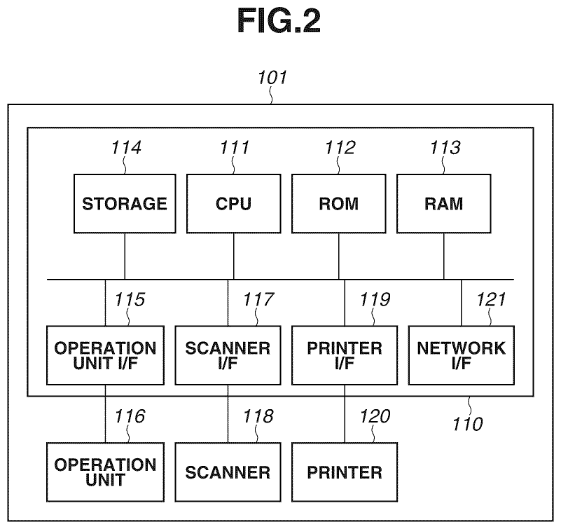

Next, with reference to FIG. 2, the hardware configuration of the MFP 101 as an example of a print control apparatus according to the present exemplary embodiment is described. FIG. 2 is a block diagram illustrating the hardware configuration of the MFP 101.

A control unit 110 including a central processing unit (CPU) 111 controls the operation of the entirety of the MFP 101. The CPU 111 reads control programs stored in a read-only memory (ROM) 112 or storage 114 and performs various types of control such as print control and reading control. The ROM 112 stores a control program that can be executed by the CPU 111. A random-access memory (RAM) 113 is a main storage memory that is accessed by the CPU 111, and is used as a work area or a temporary storage area into which various control programs are loaded. The storage 114 stores a print job, image data, various programs, and various pieces of setting information. Pieces of hardware such as the CPU 111, the ROM 112, the RAM 113, and the storage 114 thus form a so-called computer. The storage 114 also stores an access token for accessing the hardware of a user tenant on the cloud platform 102, and address information used to communicate with the CPS 105.

Although in the MFP 101 according to the present exemplary embodiment, a single CPU 111 executes print control and control for communication with the CPS 105 using a single memory (the RAM 113), another form may be employed. For example, a plurality of processors, memories, and spaces of storage can also cooperate to execute processes described below. Alternatively, some of the processes may be executed using a hardware circuit.

A printer interface (I/F) 119 connects a printer 120 (a printer engine) and the control unit 110. Based on a print job received from the CPS 105 or the information processing apparatus 103, the MFP 101 generates a print image and a print control command to be transferred to the printer 120. Based on the print image and the print control command input to the printer 120 via the printer I/F 119, the printer 120 prints an image on a sheet fed from a sheet feeding cassette (not illustrated). The printing method may be an electrophotographic method for fixing an image by transferring toner to paper, or may be an inkjet method for printing an image by discharging ink to paper.

A scanner I/F 117 connects a scanner 118 and the control unit 110. The scanner 118 reads a document placed on a document platen (not illustrated) and then generates image data. The image data generated by the scanner 118 is printed by the printer 120, stored in the storage 114, or transmitted to an external apparatus via a network I/F 121.

An operation unit I/F 115 connects an operation unit 116 and the control unit 110. The operation unit 116 includes a liquid crystal display unit having a touch panel function, and various hardware keys. The operation unit 116 functions as a display unit that displays information to the user, and a reception unit that receives an instruction from the user. The CPU 111 cooperates with the operation unit 116 to control the display of information and control the reception of a user operation.

A network cable is connected to the network I/F 121, and the MFP 101 can communicate with an external apparatus on the LAN 100 or the Internet. In the present exemplary embodiment, a case is assumed where the network I/F 121 is a wireless communication interface compliant with the IEEE 802.11 series. The present disclosure, however, is not limited to this. For example, the network I/F 121 may be a communication interface that connects a cable for a wired connection in a registered jack (RJ) 45 connector format or a GG (GigaGate) 45 connector format to the network I/F 121 and performs wired communication compliant with Ethernet. The network I/F 121 may also separately include a communication interface for performing communication using the path 1. In this case, the communication interface may be a communication interface that performs mobile communication using a third generation (3G) circuit based on code-division multiple access (CDMA), a fourth generation (4G) circuit based on LTE, or 5G New Radio (NR).

The MFP 101 having received from the CPS 105 a notification that a print job is submitted receives the print job from the CPS 105. Next, the MFP 101 renders print target data included in the print job, thereby generating print image data. The CPU 111 transmits the print image data generated by rendering the print target data and a control command for controlling the printer 120 to the printer 120 via the printer I/F 119 and causes the printer 120 to execute a printing process.

The MFP 101 supports a standard print function based on the Internet Printing Protocol (IPP). If the MFP 101 receives a printer search packet using Bonjour or multicast Domain Name Service (mDNS) from an external apparatus such as the information processing apparatus 103, the MFP 101 returns the result of the search to the packet. The result of the search includes identification information for identifying a printer.

### Configuration of Information Processing Apparatus 103

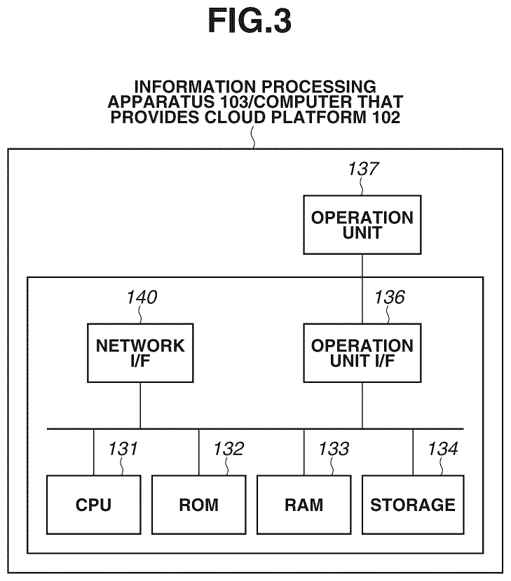

Next, with reference to FIG. 3, the hardware configuration of the information processing apparatus 103 is described. A control unit 130 including a CPU 131 controls the operation of the entirety of a computer. The CPU 131 loads programs stored in a ROM 132 or storage 134 into a RAM 133 and executes the programs, thereby performing various types of control. The RAM 133 is a main storage memory of the CPU 131 and is used as a work area or a temporary storage area into which various programs are loaded. The ROM 132 stores a control program that can be executed by the CPU 131 and a boot program.

Although in the present exemplary embodiment, a non-volatile memory such as a solid-state drive (SSD) is assumed as the storage 134, an auxiliary storage device such as a hard disk drive (HDD) may be used instead of the SSD. Pieces of hardware such as the CPU 131, the RAM 133, the ROM 132, and the storage 134 thus form a so-called computer.

An operation unit I/F 136 is an interface that controls an operation unit 137 including a touch input device, a display, a keyboard, and a pointing device (a mouse). The operation unit 137 functions as a reception unit that receives an operation from the user. The operation unit 137 also functions as a display unit that displays information to the user. The information processing apparatus 103 is connected to a network or the Internet via a network I/F 140. The information processing apparatus 103 transmits print data to a printing apparatus on the LAN 100 or communicates data with the cloud platform 102 on the Internet via the network I/F 140. The communication method may be wireless communication compliant with the IEEE 802.11 series, or may be wired communication for connecting to Ethernet via a cable for a wired connection connected to the information processing apparatus 103 in the RJ45 connector format or the GG45 connector format. The information processing apparatus 103 may communicate data with the cloud platform 102 on the Internet via a mobile communication system based on LTE or 5G.

Although in the information processing apparatus 103 according to the present exemplary embodiment, a single CPU 131 executes processes illustrated in flowcharts described below using a single memory (the RAM 133), another form may be employed. For example, a plurality of processors, memories, and spaces of storage can also be configured to cooperate to execute the processes illustrated in the flowcharts described below. Alternatively, some of the processes may be executed using a hardware circuit.

A computer as a real resource that achieves the cloud services of the cloud platform 102 also has a configuration similar to the hardware configuration described with reference to FIG. 3. That is, the cloud services illustrated in FIG. 1 are achieved by a so-called von Neumann architecture computer executing a program code.

Although in the present exemplary embodiment, for ease of description, a case is illustrated where a single CPU executes the processes of the cloud services included in the cloud platform 102 using a single memory, another form may be employed. For example, a plurality of processors, RAMs, ROMs, and spaces of storage can also cooperate to execute processes illustrated in flowcharts described below. Alternatively, resources of a plurality of server computers can also cooperate to achieve the services. The computer resource that provides the cloud platform 102 appropriately manages data resources of a plurality of different tenants by using a containerization technique or a virtualization technique according to circumstances and provides the cloud services to users belonging to the tenants.

### Software Configuration of Information Processing Apparatus 103

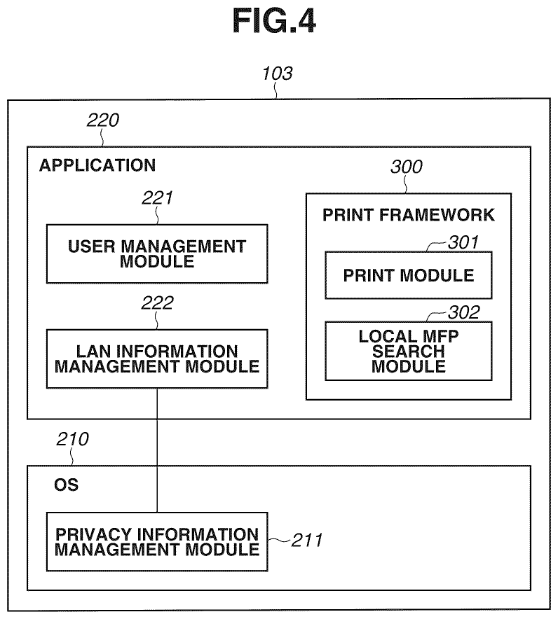

Next, with reference to FIG. 4, an example of the software configuration of the information processing apparatus 103 is described. First, operation software in the information processing apparatus 103 is described. The software in the information processing apparatus 103 includes an OS 210 and an application 220.

First, individual components included in the OS 210 are described. The OS 210 is system software that performs overall management of the entirety of the information processing apparatus 103. Specifically, the OS 210 provides the basic management and control of a computer, such as the control of input and output, the management of hardware such as a memory and a hard disk, and the management of a process. The OS 210 also provides a privacy information management module 211 for managing and controlling the permission states of various authorities requested by the application 220. The privacy information management module 211 is a module that manages the state of an authority requested by the application 220 and permitted or not permitted by selection of the user.

The privacy information management module 211 according to the present exemplary embodiment manages the state regarding whether access to the LAN 100 requested by the application 220 is permitted or not permitted by selection of the user.

Next, the application 220 is software having the function of transmitting print data to the MFP 101. An example of the application 220 is the above print application. The application 220 is called by the OS 210 through an operation of the user and operates. Using the application 220, the user can instruct the MFP 101 to perform printing.

Further, the application 220 according to the present exemplary embodiment includes a user management module 221, a LAN information management module 222, and a print framework 300. The user management module 221 manages a user account of the cloud platform 102. The user management module 221 stores an access token that is user account information regarding the cloud platform 102. In the present exemplary embodiment, a case is illustrated where the information processing apparatus 103 is authenticated by the authentication service 104 of the cloud platform 102 and managed as a device. The login authentication of a user to use the information processing apparatus 103 is also performed cooperatively with the authentication service 104 of the cloud platform 102. For illustrative purposes, a description is given below of a case where a user “Alice” is logged into the application 220 using a cloud account “aaaAlice@mail.jp” as an example.

The LAN information management module 222 is a module that manages the state of the LAN 100. In the present exemplary embodiment, the application 220 uses the LAN information management module 222 to monitor the state of the LAN 100. The application 220 also determines the state of permission for the application 220 to access the LAN 100, using the LAN information management module 222.

The print framework 300 includes a print module 301 and a local MFP search module 302. The print framework 300 performs the process of generating print data using the print module 301. The print module 301 can perform printing via the LAN 100.

When the print module 301 performs printing, the print module 301 generates a print job and transmits the print job to the MFP 101 via the LAN 100. The print job includes print target data such as a Joint Photographic Experts Group (JPEG) file or a Portable Document Format (PDF) file and print setting information such as the sheet size, the type of sheet, the two-sided setting, and the color setting. The print module 301 identifies a local MFP as an output destination, and based on ability information regarding the output destination local MFP, provides a print settings screen customized with respect to each output destination local MFP. In the present exemplary embodiment, a case is described where the print module 301 transmits a print job to a local MFP via the LAN 100. In a case where the print module 301 is to transmit a print job to a local MFP via the LAN 100, the application 220 needs to be permitted to access the LAN 100 by the user.

The local MFP search module 302 is a module that searches for an MFP on the LAN 100 to which the information processing apparatus 103 is connected. The module 302 is used to search for a new printer on an initial screen or a search screen. The module 302 is also used to update local MFPs on the LAN 100 that can be used by the user when the application 220 starts or when the application 220 returns from sleep. The module 302 broadcasts a broadcast packet for a search such as Bonjour or mDNS onto a network and searches for a network printer. For example, the module 302 can also search for a network printer through unicast communication using a Get-Printer-Attributes request defined by the IPP standard. In a case where the local MFP search module 302 is to search for a local MFP via the LAN 100, the application 220 needs to be permitted to access the LAN 100 by the user.

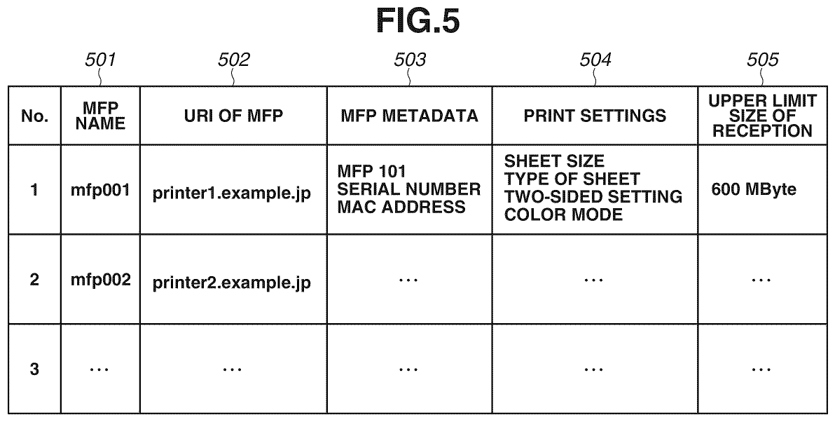

FIG. 5 illustrates an example of cloud MFP information managed by the CPS 105 and associated with the cloud account “aaaAlice@mail.jp”. Information 501 indicates an MFP name that is identification information identifying a cloud MFP on the CPS 105. Information 502 indicates the Uniform Resource Identifier (URI) of a local MFP that actually processes a print job submitted to the CPS 105. Information 503 is metadata used to display device detailed information. Information 504 indicates ability information regarding the cloud MFP displayed on a print screen or a print settings screen.

Specifically, the information 504 includes ability information such as the sheet size and the type of sheet with which the cloud MFP is compatible, ability information regarding whether two-sided printing is supported by the cloud MFP, and ability information such as the color mode supported by the cloud MFP. Information 505 stores information indicating the size of print data that can be received by the cloud MFP.

The application 220 acquires an access token corresponding to a logged-in user from the user management module 221. Next, using the access token, the application 220 calls a web application programming interface (API) provided by the CPS 105. Based on the access token, the CPS 105 having received the calling of the web API returns information regarding cloud MFPs associated with the logged-in user and information regarding the cloud storage service 106 that can be used. For example, if the CPS 105 receives a request including an access token corresponding to the cloud account “aaaAlice@mail.jp”, the CPS 105 notifies the application 220 of a list of MFPs and a list of cloud storage services associated with the account. In a case where the application 220 is to communicate with a cloud MFP on the CPS 105, the application 220 does not need to be permitted to access the CPS 105 via the LAN 100 by the user.

### Operation When Application 220 Starts

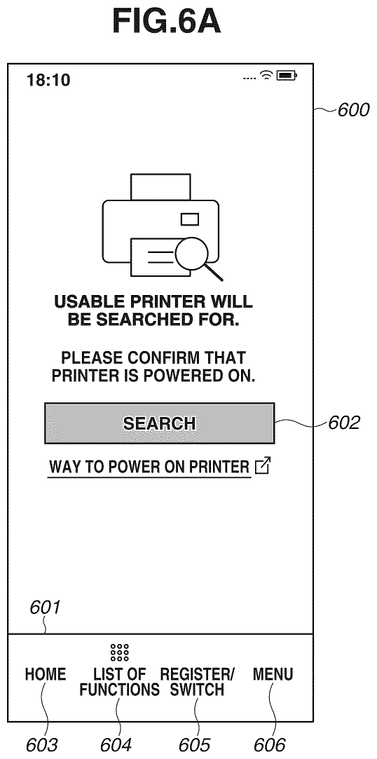

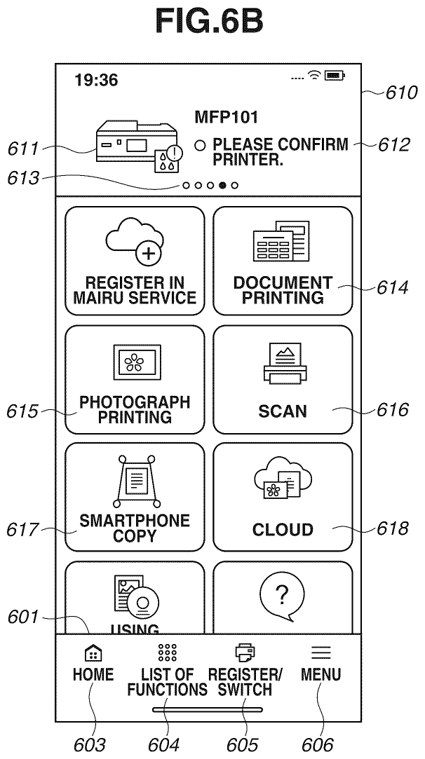

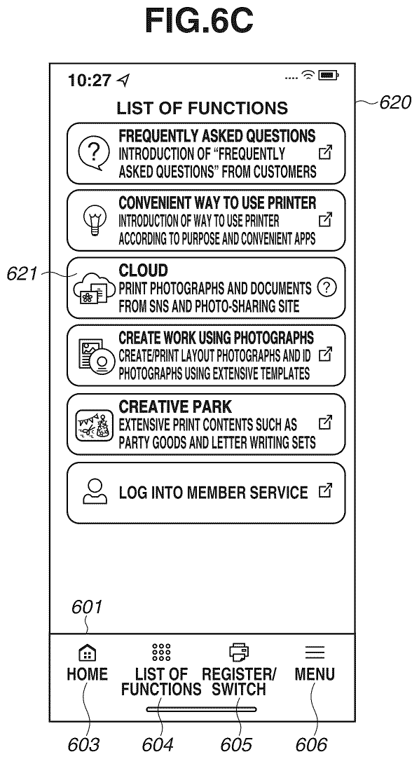

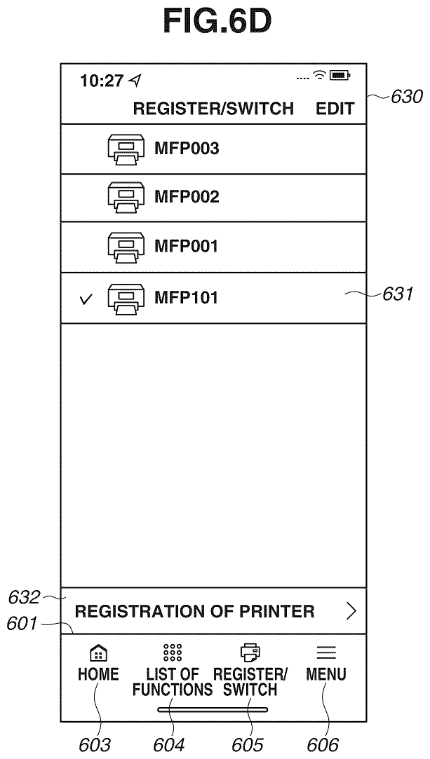

FIGS. 6A to 6D illustrate examples of screens of the application 220. The display of the screens illustrated in FIGS. 6A to 6D is controlled by the CPU 131 of the information processing apparatus 103, and the screens are displayed on the operation unit 137 that doubles as the display unit of the information processing apparatus 103. If the application 220 is called by the OS 210 according to an operation of the user and started, the application 220 switches the display state of an initial screen according to the state of the registration of a local MFP in the application 220. Specifically, in a case where the application 220 has not searched for a local MFP and registered a local MFP in the past, such as a case where the application 220 is started for the first time, the application 220 displays an initial screen 600 when a local MFP has not yet been registered that is illustrated in FIG. 6A. In a case where the application 220 has been started and has searched for a local MFP and registered a local MFP in the past, the application 220 displays an initial screen 610 when a local MFP is registered that is illustrated in FIG. 6B. According to the display of the initial screen 600 or 610, the application 220 starts monitoring the state of the LAN 100 using the LAN information management module 222. By monitoring the state of the LAN 100, the application 220 can acquire from the privacy information management module 211 of the OS 210 the state regarding whether the application 220 is not permitted to access the LAN 100.

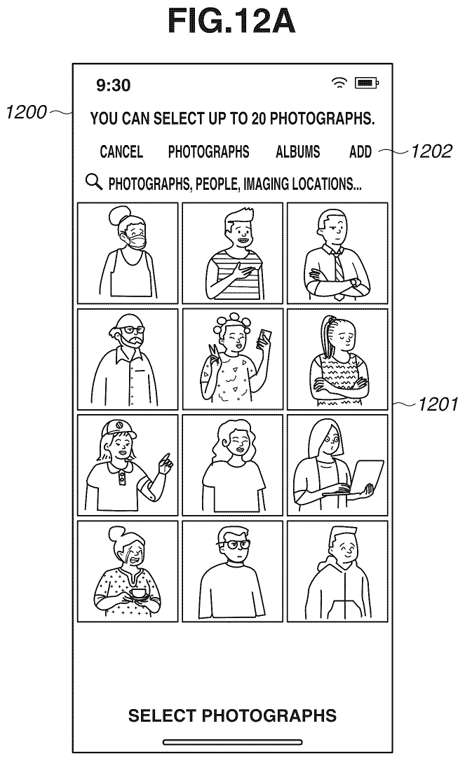

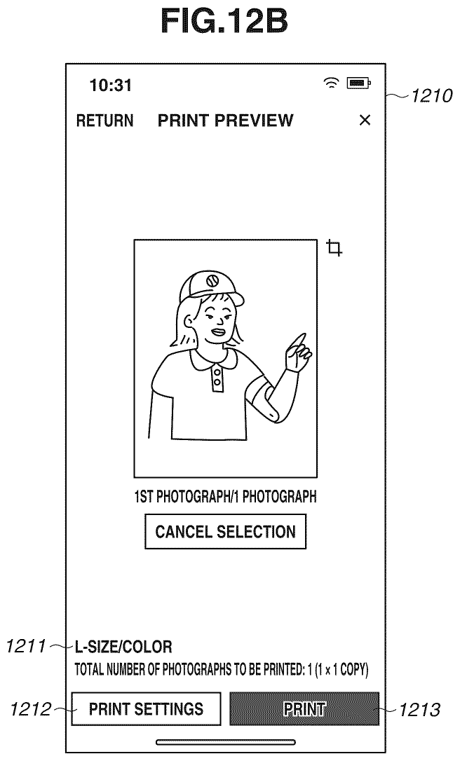

While a screen of the application 220 is displayed on the operation unit 137, the application 220 continues monitoring the state of the LAN 100. When the screen of the application 220 ceases to be displayed on the operation unit 137 by an operation of the user, the application 220 finishes monitoring the state of the LAN 100. The present disclosure, however, is not limited to this. While the initial screen 600 or 610 is displayed on the operation unit 137, the application 220 may continue monitoring the state of the LAN 100. When another screen (e.g., a photograph selection screen 1200 in FIG. 12A) is displayed, the application 220 may finish monitoring the state of the LAN 100. In this manner, the application 220 can monitor the state of the LAN 100 only when a screen where the state of permission to access the LAN 100 needs to be determined is displayed.

The initial screen 600 when a local MFP has not yet been registered that is illustrated in FIG. 6A includes a tab area 601 and a search button 602 for starting searching for a local MFP. The tab area 601 includes a “home” button 603 for displaying an initial screen, a “list of functions” button 604 for displaying a list of functions with which the application 220 is compatible, a “register/switch” button 605 for searching for a local MFP and additionally registering a local MFP in the application 220 or for switching registered local MFPs, and a “menu” button 606 for displaying a menu related to the application 220. If the “list of functions” button 604 is pressed, the application 220 displays a “list of functions” screen 620 illustrated in FIG. 6C. If the “register/switch” button 605 is pressed, the application 220 displays a “register/switch” screen 630 illustrated in FIG. 6D. Each button is an example of a display item, and may not be in the form of a button.

The initial screen 610 when a local MFP is registered that is illustrated in FIG. 6B includes, in addition to the tab area 601, a local MFP area 613 including a local MFP button 611 for displaying detailed information regarding a local MFP and a local MFP status area 612 for displaying the state of the local MFP. The initial screen 610 also includes a “document printing” button 614, a “photograph printing” button 615, a “scan” button 616, and a “copy” button 617 for executing document printing, photograph printing, scanning, and copying, respectively, using the local MFP.

FIG. 6C illustrates the “list of functions” screen 620 displayed by the application 220 in a case where the “list of functions” button 604 is pressed in FIG. 6A. The “list of functions” screen 620 includes a “cloud” button 621 for executing printing and scanning using a cloud MFP. Also, on the “list of functions” screen 620, items displayed by the application 220 differ depending on whether a local MFP is registered. The “list of functions” screen 620 illustrates a “list of functions” screen when a local MFP has not yet been registered. In this case, even if a local MFP is not registered, the application 220 displays a list of functions that can be used by a cloud MFP. If a local MFP is registered, the “list of functions” screen 620 changes to a “list of functions” screen when a local MFP is registered, and the application 220 displays buttons corresponding to functions (e.g., document printing, photograph printing, scanning, and copying) that can be used by a local MFP.

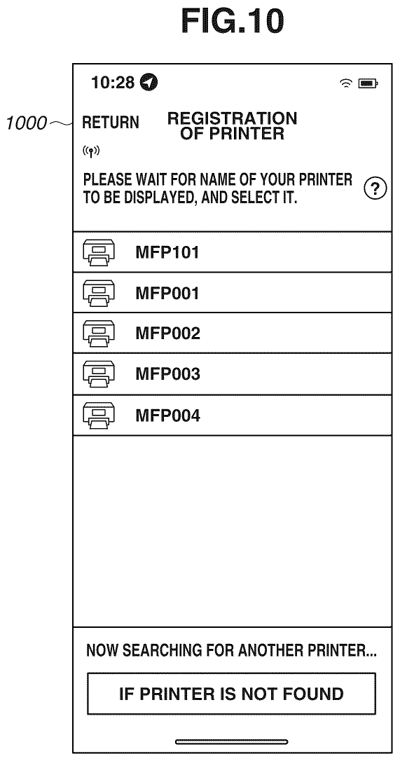

FIG. 6D illustrates the “register/switch” screen 630 displayed by the application 220 in a case where the “register/switch” button 605 is pressed in FIG. 6B. The “register/switch” screen 630 includes a list of registered local MFPs 631 and a search button 632. The list of registered local MFPs 631 displays a list of local MFPs registered in the application 220. If a local MFP is selected from the list of registered local MFPs 631, the application 220 sets the selected local MFP as an output destination MFP. The search button 632 is a button for displaying a search screen 1000 illustrated in FIG. 10 for searching for a local MFP.

On the initial screen 600 illustrated in FIG. 6A, the initial screen 610 illustrated in FIG. 6B, or the “list of functions” screen 620 illustrated in FIG. 6C, either or both a local MFP or/and a cloud MFP may be used. Thus, the application 220 monitors the state of the LAN 100 while the screen is displayed, but does not determine whether the state of permission for the application 220 to access the LAN 100 is the state where the application 220 is not permitted to access the LAN 100. The initial screen 610 illustrated in FIG. 6B and the “list of functions” screen 620 illustrated in FIG. 6C may display redundant functions. For example, the “cloud” button 621 illustrated in FIG. 6C may be displayed on the initial screen 610 illustrated in FIG. 6B. Also in this case, the “cloud” button 621 provides a function that uses a cloud MFP.

### Operation When Local MFP is Searched For

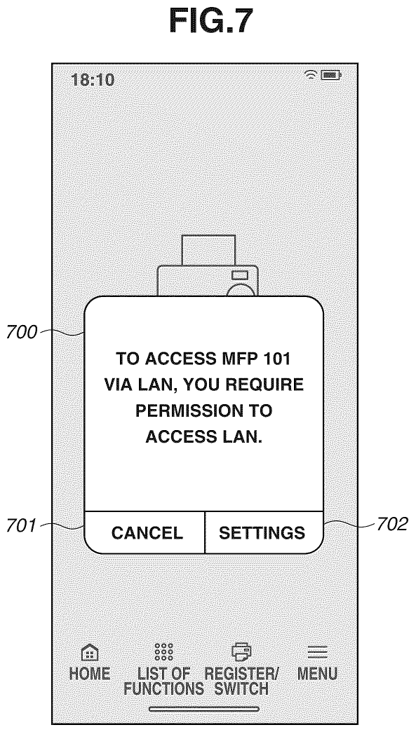

According to the pressing of the search button 602 illustrated in FIG. 6A, then using the LAN information management module 222, the application 220 determines whether the application 220 is permitted to access the LAN 100. For the determination, information regarding the state of permission to access the LAN 100 acquired from the privacy information management module 211 of the OS 210 by monitoring the state of the LAN 100 is used. If the information acquired from the information management module 211 is information indicating that the application 220 is not permitted to access the LAN 100, the application 220 displays an error screen 700 illustrated in FIG. 7 including a message that the application 220 is not permitted to access the LAN 100.

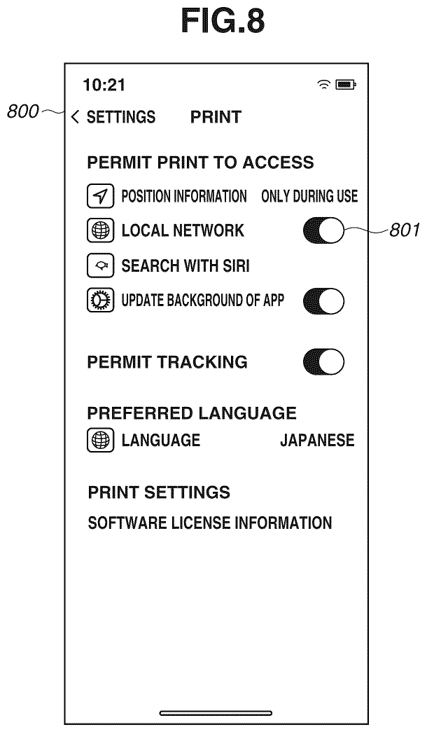

The error screen 700 illustrated in FIG. 7 includes a “cancel” button 701 and a “settings” button 702. If the “cancel” button 701 is pressed, the application 220 closes the error screen 700 and suspends the previously executed process (a search process for searching for a local MFP according to the pressing of the search button 602 in this case). If the “settings” button 702 is pressed, the application 220 displays a “settings” screen 800 illustrated in FIG. 8 that is an OS settings screen managed, controlled, and displayed by the OS 210.

The “settings” screen 800 illustrated in FIG. 8 includes a switch 801 for changing the state of permission for the application 220 to access the LAN 100. If the switch 801 is turned on (enabled) by the user, the application 220 enters the state where the application 220 is permitted to access the LAN 100. If the switch 801 is turned off (disabled) by the user, the application 220 enters the state where the application 220 is not permitted to access the LAN 100. The state where the application 220 is not permitted to access the LAN 100 is, for example, the state in a case where the “cancel” button 701 in FIG. 7 is selected or a case where the switch 801 is set to off by the user. After the state of permission to access the LAN 100 is changed on the “settings” screen 800, if an operation for displaying the application 220 is executed by tapping an icon (not illustrated) of the application 220, the application 220 displays the initial screen 600 and resumes the previously executed process (the search process for searching for a local MFP according to the pressing of the search button 602 in this case).

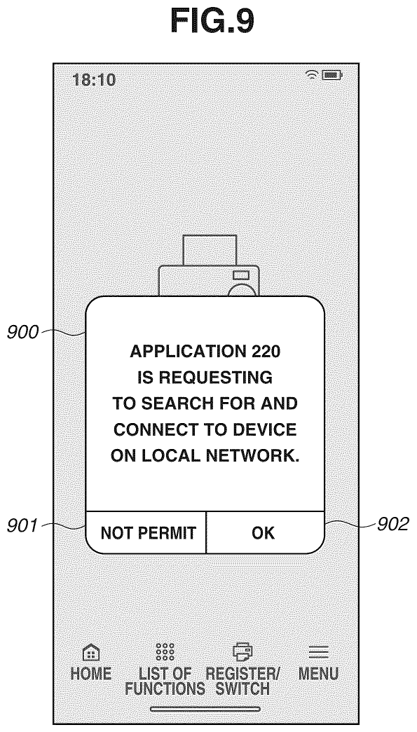

When the search button 602 illustrated in FIG. 6A is pressed, and if the state of permission for the application 220 to access the LAN 100 is the state where the application 220 has not yet been permitted to access the LAN 100, the OS 210 displays a confirmation screen 900 illustrated in FIG. 9 including a message requesting permission to access the LAN 100. The state where the application 220 has not yet been permitted to access the LAN 100 is, for example, the state in a case where the application 220 is started for the first time after the application 220 is installed on the information processing apparatus 103. The confirmation screen 900 includes a “not permit” button 901 and an “OK” button 902. If the “not permit” button 901 is pressed, the OS 210 closes the confirmation screen 900 in the state where the application 220 is not permitted to access the LAN 100. By this operation, the switch 801 illustrated in FIG. 8 for changing the state of permission to access the LAN 100 changes to the off state. If the “OK” button 902 is pressed, the OS 210 closes the confirmation screen 900 in the state where the application 220 is permitted to access the LAN 100. By this operation, the switch 801 illustrated in FIG. 8 for changing the state of permission to access the LAN 100 changes to the on state. Similarly to the above processing, the application 220 determines the state of permission to access the LAN 100. If the state of permission to access the LAN 100 is the state where the application 220 is not permitted to access the LAN 100, the application 220 displays the error screen 700 illustrated in FIG. 7.

When the search button 602 illustrated in FIG. 6A is pressed or after the confirmation screen 900 is displayed, if the state of permission to access the LAN 100 is neither the state where the application 220 is not permitted to access the LAN 100 nor the state where the application 220 has not yet been permitted to access the LAN 100, the application 220 executes a search process for searching for a local MFP using the local MFP search module 302.

As described above, the state of permission to access the LAN 100 is determined after the pressing of the search button 602, whereby it is possible to limit the display of the error screen 700 or the confirmation screen 900 to a case where it is necessary to communicate via the LAN 100. That is, only in a case where the user explicitly selects a function that uses a LAN, an error screen or a confirmation screen is displayed. In a case where another function is selected, the error screen and the confirmation screen are not displayed. Thus, it is possible to prevent the situation where usability decreases by uniformly displaying the error screen or the confirmation screen. For example, even if the “cloud” button 621 is selected in FIG. 6C in the state where the application 220 is not permitted to access the LAN 100, the error screen 700 and the confirmation screen 900 are not displayed. If it is not necessary to search for a local MFP, it is possible to return to the previous screen (the initial screen 600 in this case) by pressing the “cancel” button 701 included in the error screen 700. Thus, it is possible to use the application 220 to confirm another function that uses a cloud MFP or a manual without permitting the application 220 to access the LAN 100. This improves convenience for the user.

If the “register/switch” button 605 illustrated in FIGS. 6A and 6B is pressed by the user, the application 220 displays the “register/switch” screen 630 illustrated in FIG. 6D.

If the search button 632 is pressed, the application 220 displays the search screen 1000 illustrated in FIG. 10 for searching for a local MFP. The search screen 1000 displays a list of local MFPs found by the local MFP search module 302. According to the pressing of the search button 632, the application 220 displays the search screen 1000.

According to the display of the search screen 1000, then using the LAN information management module 222, the application 220 determines whether the application 220 is permitted to access the LAN 100. Similarly to the case where the search button 602 on the initial screen 600 is pressed, if the result of the determination indicates the state where the application 220 is not permitted to access the LAN 100, the application 220 displays the error screen 700. If the result of the determination indicates the state where the application 220 has not yet been permitted to access the LAN 100, the OS 210 displays the confirmation screen 900. If the result of the determination indicates neither the state where the application 220 is not permitted to access the LAN 100 nor the state where the application 220 has not yet been permitted to access the LAN 100, the application 220 executes a search process for searching for a local MFP using the local MFP search module 302. That is, in a case where the search button 632 is pressed, and if the application 220 is permitted to access the LAN 100, the application 220 searches for an MFP to connect to the LAN 100 via the LAN 100 and displays the result of the search on the search screen 1000. For example, the MFP 101 is displayed as the result of the search. On the other hand, in a case where the search button 632 is pressed, and if the application 220 is not permitted to access the LAN 100, the error screen 700 or the confirmation screen 900 is displayed.

Also in this case, the state of permission to access the LAN 100 is determined after the pressing of the search button 632, whereby it is possible to limit the display of the error screen 700 or the confirmation screen 900 to a case where it is necessary to communicate via the LAN 100. If it is not necessary to search for a local MFP, it is possible to return to the previous screen (the “register/switch” screen 630 in this case) by pressing the “cancel” button 701 included in the error screen 700. Thus, it is possible to use the application 220 to confirm another function that uses a cloud MFP or a manual without permitting the application 220 to access the LAN 100. This improves convenience for the user.

### Local MFP Search Sequence

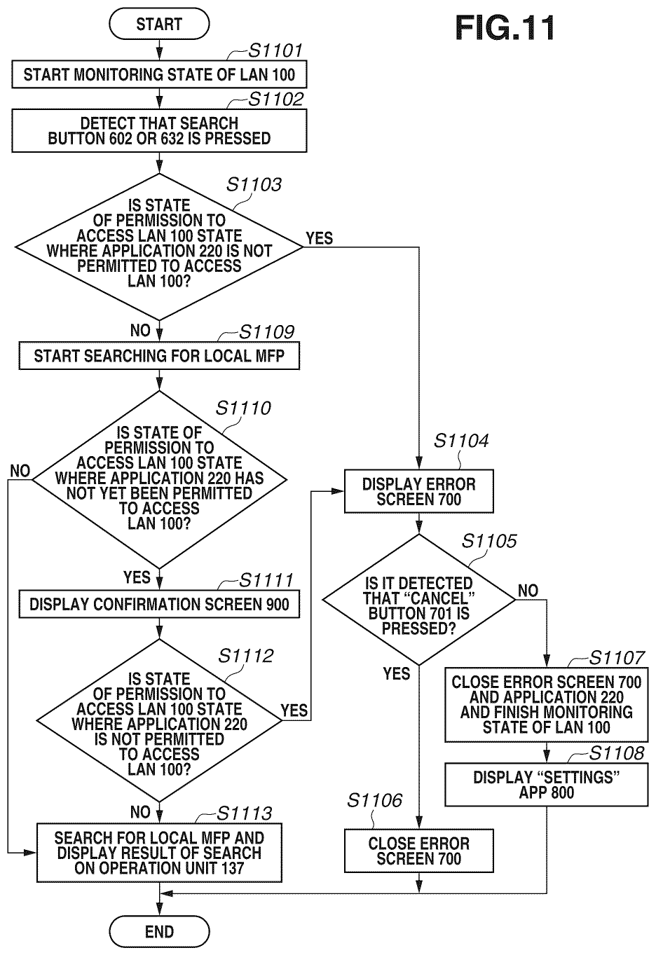

FIG. 11 is a flowchart illustrating a local MFP search sequence of the application 220. With reference to FIG. 11, a description is given of a processing sequence of the application 220 when a local MFP is searched for. This flowchart illustrates a processing sequence after the application 220 displays the initial screen 600 in FIG. 6A or the “register/switch” screen 630 in FIG. 6D.

In step S1101, the application 220 starts monitoring the state of the LAN 100 using the LAN information management module 222. In step S1102, the application 220 detects that the search button 602 on the initial screen 600 or the search button 632 on the “register/switch” screen 630 is pressed. In step S1103, using the result of monitoring the state of the LAN 100, the LAN information management module 222 of the application 220 determines whether the state of permission to access the LAN 100 is the state where the application 220 is not permitted to access the LAN 100. If it is determined that the state of permission to access the LAN 100 is the state where the application 220 is not permitted to access the LAN 100 (YES in step S1103), then in step S1104, the application 220 displays the error screen 700. If it is detected that the “cancel” button 701 is pressed on the error screen 700 (YES in step S1105), then in step S1106, the application 220 closes the error screen 700, and this processing sequence ends. If it is detected that the “settings” button 702 is pressed on the error screen 700 (NO in step S1105), then in step S1107, the application 220 closes the error screen 700 and the screen of the application 220 and finishes monitoring the state of the LAN 100. In step S1108, the “settings” app 800 is displayed. If the application 220 detects that the application 220 is displayed on the operation unit 137 again, the application 220 resumes this processing sequence from step S1101 or S1103.

If it is determined that the state of permission to access the LAN 100 is not the state where the application 220 is not permitted to access the LAN 100 (NO in step S1103), then in step S1109, the application 220 starts searching for a local MFP using the local MFP search module 302. At this time, if the OS 210 determines that the state of permission to access the LAN 100 is the state where the application 220 has not yet been permitted to access the LAN 100 (YES in step S1110), then in step S1111, the OS 210 displays the confirmation screen 900.

If the “not permit” button 901 is pressed on the confirmation screen 900, the OS 210 closes the confirmation screen 900. Next, the LAN information management module 222 of the application 220 monitoring the state of the LAN 100 detects that the state of permission to access the LAN 100 changes to the state where the application 220 is not permitted to access the LAN 100. If the application 220 detects that the state of permission to access the LAN 100 changes to the state where the application 220 is not permitted to access the LAN 100 (YES in step S1112), then in step S1104, the application 220 displays the error screen 700. If the “OK” button 902 is pressed on the confirmation screen 900 (NO in step S1112), the OS 210 closes the confirmation screen 900. Next, in step S1113, the application 220 searches for a local MFP using the local MFP search module 302 and displays the result of the search on the operation unit 137. If the state of permission to access the LAN 100 is not the state where the application 220 has not yet been permitted to access the LAN 100 (NO in step S1110), then in step S1113, the application 220 searches for a local MFP using the local MFP search module 302 and displays the result of the search on the operation unit 137, and this processing sequence ends.

By such a processing sequence, it is possible to limit the display of the error screen 700 or the confirmation screen 900 to a case where it is necessary to communicate via the LAN 100. If it is not necessary to search for a local MFP, it is possible to end this processing sequence by pressing the “cancel” button 701 included in the error screen 700. Thus, it is possible to use the application 220 to confirm another function that uses a cloud MFP or a manual without permitting the application 220 to access the LAN 100. This improves convenience for the user.

### Operation When Printing Using Local MFP is Performed

If the “photograph printing” button 615 is pressed on the initial screen 610 illustrated in FIG. 6B, the application 220 displays the photograph selection screen 1200 illustrated in FIG. 12A. The photograph selection screen 1200 displays a list of photographs 1201 that can be accessed by the information processing apparatus 103, and an “add” button 1202. Each of the photographs displayed in the list of photographs 1201 is in the form of a button. If any of the photographs is pressed, the pressed photograph enters a selected state. If the “add” button 1202 is pressed in the state where any of the photographs is selected on the photograph selection screen 1200, the application 220 displays a “print preview” screen 1210 illustrated in FIG. 12B with the selected photograph as a print target photograph.

The “print preview” screen 1210 displays print setting information 1211, a “print settings” button 1212, and a “print” button 1213 in addition to the preview display of the photograph selected on the photograph selection screen 1200. In the print setting information 1211, information such as the sheet size, the color mode, and the number of images to be printed is displayed as current print setting values. In view of the print setting information 1211 illustrated in FIG. 12B, it is understood that the sheet size used for printing is an L-size, the color mode is color, and the number of images to be printed is one. If the “print settings” button 1212 is pressed, the application 220 displays a print settings screen (not illustrated). The print settings screen is configured based on ability information regarding a local MFP and displays setting values that can be used by a currently selected local MFP. Specifically, the setting values are the sheet size, the type of sheet, the border setting, the color mode, photograph correction, and the two-sided setting. If the print settings are changed on the print settings screen, the application 220 updates the information displayed in the print setting information 1211 on the “print preview” screen 1210. If the “print” button 1213 is pressed, then using the LAN information management module 222, the application 220 determines whether the application 220 is permitted to access the LAN 100. Similarly to the case where the search button 602 on the initial screen 600 is pressed, if the result of the determination indicates the state where the application 220 is not permitted to access the LAN 100, the application 220 displays the error screen 700. If the result of the determination does not indicate the state where the application 220 is not permitted to access the LAN 100, the application 220 starts a printing process using the print module 301.

Also in this case, the state of permission to access the LAN 100 is determined after the pressing of the “print” button 1213, whereby it is possible to limit the display of the error screen 700 to a case where it is necessary to communicate via the LAN 100. If it is not necessary to perform printing using a local MFP, it is possible to return to the previous screen (the “print preview” screen 1210 in this case) by pressing the “cancel” button 701 included in the error screen 700. Thus, it is possible to use the application 220 to confirm another function that uses a cloud MFP or a manual without permitting the application 220 to access the LAN 100. This improves convenience for the user.

Although in the present exemplary embodiment, a case has been described where the “photograph printing” button 615 is pressed on the initial screen 610, the same applies to another function that uses a local MFP as an output destination MFP. Specifically, if the “document printing” button 614 is pressed, screens displayed by the application 220 are a document selection screen (not illustrated) for selecting a document and a document preview screen (not illustrated) for previewing a document selected on the document selection screen (not illustrated) and executing printing. The application 220 determines the state of permission to access the LAN 100 using the LAN information management module 222 in a case where a “print” button for printing selected document data is pressed on the document preview screen (not illustrated). Thus, it is possible to achieve an effect similar to that in the case where the “photograph printing” button 615 is pressed.

The same applies to a case where the “scan” button 616 is pressed on the initial screen 610. In this case, according to the pressing of the “scan” button 616, the application 220 displays a scan screen (not illustrated). According to the pressing of a scanning execution button for executing scanning on the scan screen (not illustrated), the application 220 determines the state of permission to access the LAN 100 using the LAN information management module 222. That is, if the state of permission to access the LAN 100 is the state where the application 220 is not permitted to access the LAN 100, the application 220 displays the error screen 700 only in a case where it is necessary to communicate with a local MFP. Thus, it is possible to obtain an effect similar to that in the case where the “photograph printing” button 615 is pressed.

To execute an operation when printing using a local MFP is performed, generally, a search process for searching for a local MFP is executed in advance by the local MFP search module 302, and the state of permission to access the LAN 100 is the state where the application 220 is permitted to access the LAN 100. However, by operating the switch 801 displayed on the “settings” app 800 for changing the state of permission to access the LAN 100, the user can switch the state of permission to access the LAN 100 any time. Thus, every time an operation of communicating via the LAN 100 is executed by the user, it is necessary to check the state of permission to access the LAN 100 and appropriately notify the user of the state. Thus, the application 220 benefits from the determination of the state of permission to access the LAN 100 by this operation also when printing is performed.

### Printing Sequence Using Local MFP

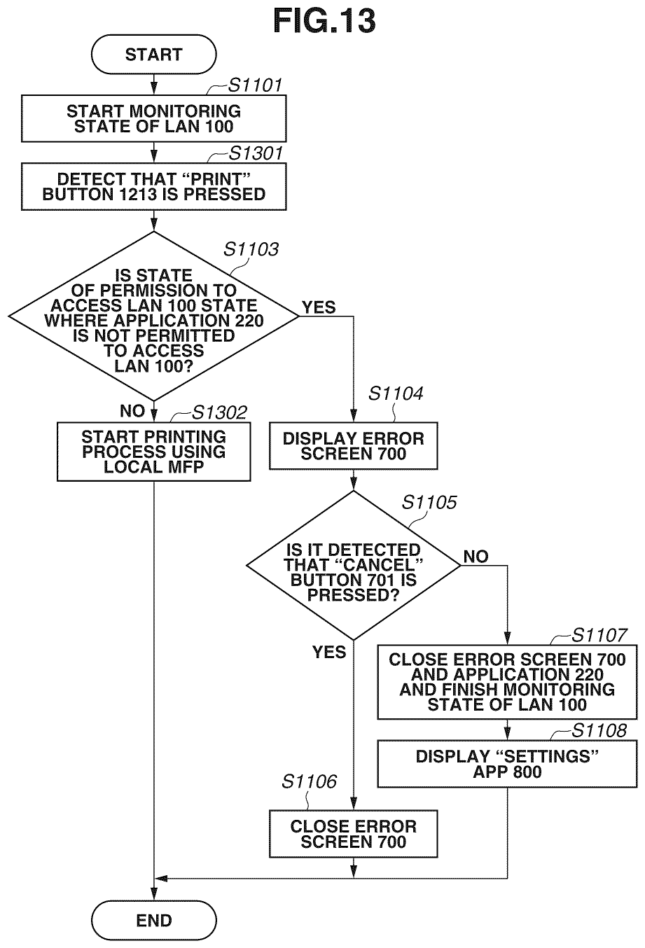

FIG. 13 is a flowchart illustrating a printing sequence of the application 220 using a local MFP. With reference to FIG. 13, a description is given of a processing sequence of the application 220 when printing using a local MFP is performed. This flowchart illustrates a processing sequence after the application 220 displays the initial screen 610 in FIG. 6B.

In step S1101, the application 220 starts monitoring the state of the LAN 100 using the LAN information management module 222. In step S1301, the application 220 detects that the “print” button 1213 on the “print preview” screen 1210 is pressed. In step S1103, using the result of monitoring the state of the LAN 100, the LAN information management module 222 of the application 220 determines whether the state of permission to access the LAN 100 is the state where the application 220 is not permitted to access the LAN 100. If it is determined that the state of permission to access the LAN 100 is the state where the application 220 is not permitted to access the LAN 100 (YES in step S1103), then in step S1104, the application 220 displays the error screen 700.

If it is detected that the “cancel” button 701 is pressed on the error screen 700 (YES in step S1105), then in step S1106, the application 220 closes the error screen 700, and this processing sequence ends. If it is detected that the “settings” button 702 is pressed on the error screen 700 (NO in step S1105), then in step S1107, the application 220 closes the error screen 700 and the screen of the application 220 and finishes monitoring the state of the LAN 100. In step S1108, the “settings” app 800 is displayed. If the application 220 detects that the application 220 is displayed on the operation unit 137 again, the application 220 resumes this processing sequence from step S1101. In this case, a screen displayed by the application 220 is the “print preview” screen 1210. Although the sequence is resumed from step S1101 in this case, a configuration may be employed in which the sequence is resumed from step S1103.

If it is determined that the state of permission to access the LAN 100 is not the state where the application 220 is not permitted to access the LAN 100 (NO in step S1103), then in step S1302, the application 220 starts a printing process using a local MFP through the use of the print module 301, and this processing sequence ends. That is, in this case, a print job is transmitted to the MFP 101 via the LAN 100.

By such a processing sequence, it is possible to limit the display of the error screen 700 to a case where it is necessary to communicate via the LAN 100. If it is not necessary to perform printing using a local MFP, it is possible to end this processing sequence by pressing the “cancel” button 701 included in the error screen 700. Thus, it is possible to use the application 220 to confirm another function that uses a cloud MFP or a manual without permitting the application 220 to access the LAN 100. This improves convenience for the user.

By the above processing, in a case where the user selects a function to be executed in the state where the application 220 is not permitted to access a LAN, and if the selected function uses the LAN, an error screen or a confirmation screen is displayed, and if the selected function is a function that does not use the LAN, the error screen and the confirmation screen are not displayed. That is, control is changed according to whether the selected function uses the LAN.

### Operation When Printing Using Cloud MFP is Performed

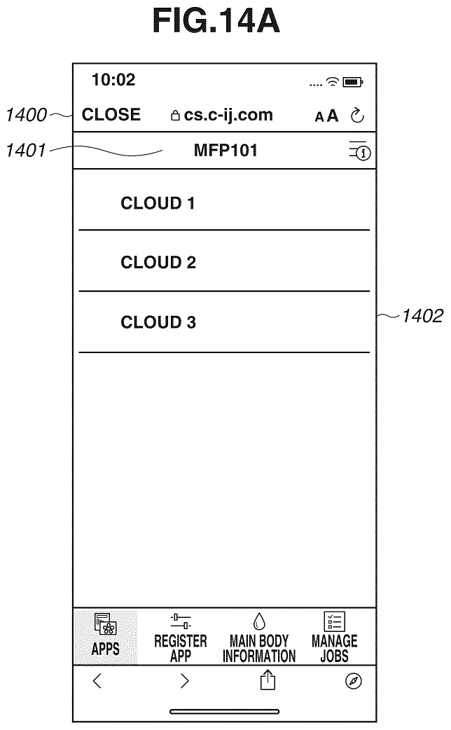

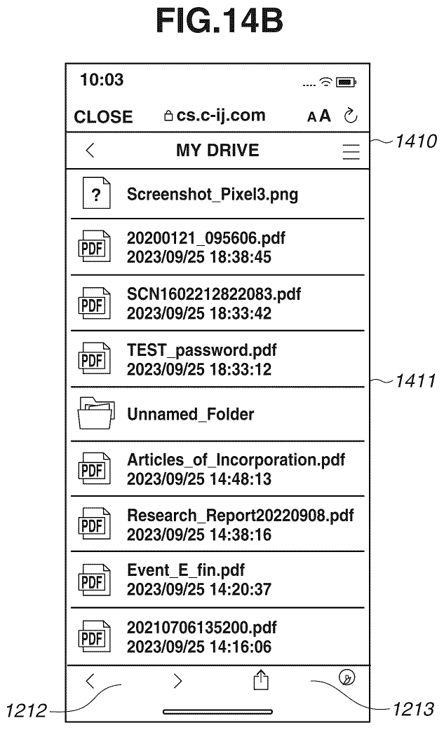

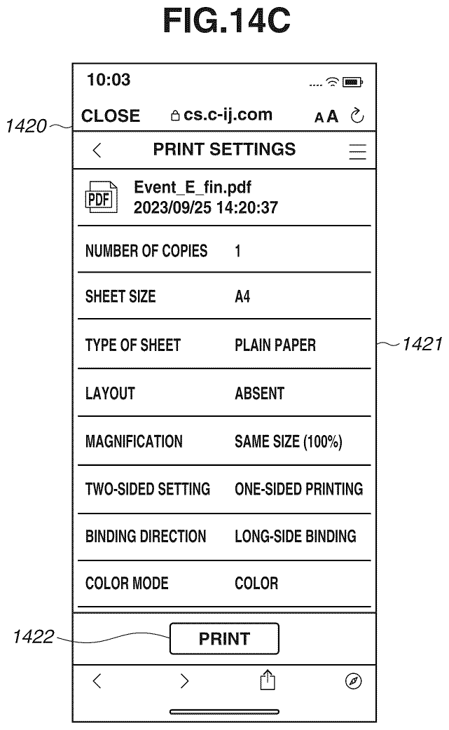

If the “cloud” button 621 is pressed on the “list of functions” screen 620 illustrated in FIG. 6C, the application 220 displays a “list of cloud services” screen 1400 illustrated in FIG. 14A. At this time, the application 220 communicates with the cloud platform 102 and performs user authentication. Specifically, using “aaaAlice@mail.jp” as a cloud account and a password corresponding to the cloud account, the application 220 logs into the cloud platform 102 as the user “Alice”. In the present exemplary embodiment, the cloud account and the password corresponding to the cloud account are held in advance by the application 220, and even if the user does not perform a login operation, user authentication is performed by the application 220 and the cloud platform 102 communicating with each other.

The “list of cloud services” screen 1400 illustrated in FIG. 14A includes cloud MFP information 1401 and a list of cloud services 1402. The cloud MFP information 1401 indicates information regarding a currently selected cloud MFP in information held by the CPS 105 and regarding cloud MFPs that can be used by the user. FIG. 14A indicates that the MFP 101 is selected as a cloud MFP. The list of cloud services 1402 is a list of cloud services capable of acquiring print data and includes cloud storage services 106 such as Google Drive™, Dropbox®, OneDrive®, and Google Photos™. In the list of cloud services 1402, each of the cloud storage services 106 is in the form of a button. If any of the cloud storage services 106 is pressed, the application 220 displays a cloud data selection screen 1410 illustrated in FIG. 14B. At this time, the application 220 executes a login process for logging into the cloud storage service 106. Although it is necessary for the user to input login information regarding the cloud storage service 106 in this login process, it is also possible to hold an access token of the user having logged in once and skip the input of the login information from the next time onward.

The cloud data selection screen 1410 illustrated in FIG. 14B includes a data list 1411 of photographs and documents saved in the pressed cloud storage service 106. In the data list 1411, the file names of the pieces of data are displayed, and each of the file names is in the form of a button. If any of the file names is pressed by the user, the application 220 displays a print screen 1420 illustrated in FIG. 14C with the file indicated by the pressed file name as print target data.

The print screen 1420 illustrated in FIG. 14C displays print setting information 1421 and a “print” button 1422 in addition to information regarding the file selected on the cloud data selection screen 1410. In the print setting information 1421, information such as the sheet size, the type of sheet, the color mode, and the two-sided setting is displayed as current print setting values. In view of the print setting information 1421 illustrated in FIG. 14C, it is understood that the sheet size used for printing is A4, the type of sheet is plain paper, the color mode is color, and the two-sided setting is one-sided printing. Each of the pieces of print setting information included in the print setting information 1421 is in the form of a button. If any of the buttons is pressed, the application 220 displays a print settings screen (not illustrated). The print settings screen is configured based on ability information regarding a cloud MFP and displays setting values that can be used by a currently selected cloud MFP. Specifically, the setting values are the sheet size, the type of sheet, the border setting, the color mode, photograph correction, and the two-sided setting. If the print settings are changed on the print settings screen, the application 220 updates the information displayed in the print setting information 1421 on the print screen 1420. If the “print” button 1422 is pressed, the application 220 transmits a print job including print data and the print setting information to the CPS 105. The CPS 105 having received the print job notifies a local MFP corresponding to the currently selected cloud MFP that a print job is transmitted. The local MFP having received the notification receives the print job from the CPS 105 and starts a printing process. If the printing is completed, the local MFP notifies the CPS 105 of the result of the printing.

Although a description has been given of screen transition and processing in a case where the “cloud” button 621 is pressed on the “list of functions” screen 620 illustrated in FIG. 6C, similar screen transition and processing may be performed also in a case where a “cloud” button 618 on the initial screen 610 illustrated in FIG. 6B is pressed. The role of the application 220 and the role of the CPS 105 described in the present exemplary embodiment are merely examples, and are not limited to these. A print job only needs to be able to be transmitted via the CPS 105 by the application 220 and the CPS 105 communicate with each other. The CPS 105 may hold information regarding each screen, and the application 220 may only display screen information received from the CPS 105. In this case, the application 220 serves a role as a web browser.

In a case where printing is executed via the CPS 105 as described above, the application 220 does not communicate with a local MFP via the LAN 100, and therefore does not need to be permitted to access the LAN 100. Thus, the application 220 does not determine the state of permission to access the LAN 100, and does not display the error screen 700, either. If the user selects the “cloud” button 618 or 621, it is possible to execute printing using a cloud MFP without permitting the application 220 to access the LAN 100. Thus, an error screen and a confirmation screen regarding a LAN are not displayed. This improves convenience for the user.

In a case where a “cloud” button is displayed on the initial screen 610 illustrated in FIG. 6B, generally, a search process for searching for a local MFP is executed in advance by the local MFP search module 302, and the state of permission to access the LAN 100 is the state where the application 220 is permitted to access the LAN 100. However, by operating the switch 801 displayed on the “settings” app 800 for changing the state of permission to access the LAN 100, the user can switch the state of permission to access the LAN 100 any time. Thus, even in a case where a “cloud” button is displayed on the initial screen 610 illustrated in FIG. 6B, it is possible to use the application 220 by setting the state of permission to access the LAN 100 to the state where the application 220 is not permitted to access the LAN 100. For a user who wishes to execute printing via the CPS 105, the state of permission to access the LAN 100 is set to the state where the application 220 is not permitted to access the LAN 100, whereby the application 220 does not communicate with another device via the LAN 100. This leads to the protection of privacy information.

### Printing Sequence Using Cloud MFP

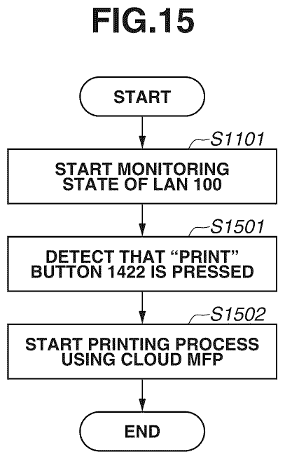

FIG. 15 is a flowchart illustrating a printing sequence of the application 220 using a cloud MFP. With reference to FIG. 15, a description is given of a processing sequence of the application 220 when printing using a cloud MFP is performed. This flowchart illustrates a processing sequence after the application 220 displays the “list of functions” screen 620 in FIG. 6C.

In step S1101, the application 220 starts monitoring the state of the LAN 100 using the LAN information management module 222. Next, in step S1501, the application 220 detects that the “print” button 1422 on the print screen 1420 is pressed. In step S1502, the application 220 starts a printing process using a cloud MFP via the CPS 105, and this processing sequence ends. For example, in this case, a print job is transmitted to the MFP 101 through public communication.

As described above, in the printing sequence using a cloud MFP via the CPS 105, the application 220 does not communicate with a local MFP via the LAN 100, and therefore does not need to be permitted to access the LAN 100. Thus, the processing sequence illustrated in FIG. 15 does not include the process of determining the state of permission to access the LAN 100. Consequently, the application 220 does not display the error screen 700. The user can execute printing using a cloud MFP without permitting the application 220 to access the LAN 100. This improves convenience for the user.

As illustrated above, in a case where the application 220 is not permitted to communicate via a LAN, and if the “print” button 1213 for the information processing apparatus 103 to transmit a print job to an MFP using the LAN is selected, an error screen or a confirmation screen regarding the LAN is displayed. If the “print” button 1422 for the information processing apparatus 103 to transmit a print job to an MFP via a cloud is selected, the error screen and the confirmation screen regarding the LAN are not displayed. Even if buttons have the identical function of transmitting a print job, the control of the buttons is changed according to whether the LAN is used, thereby preventing the error screen and the confirmation screen from being displayed to the user more than necessary. Also, in a case where a printer is searched for and a printer is registered, and if a printer is searched for and a printer is registered via the LAN, the error screen or the confirmation screen regarding the LAN is displayed. If a printer is searched for and a printer is registered via a cloud, the error screen and the confirmation screen regarding the LAN 100 can be prevented from being displayed.

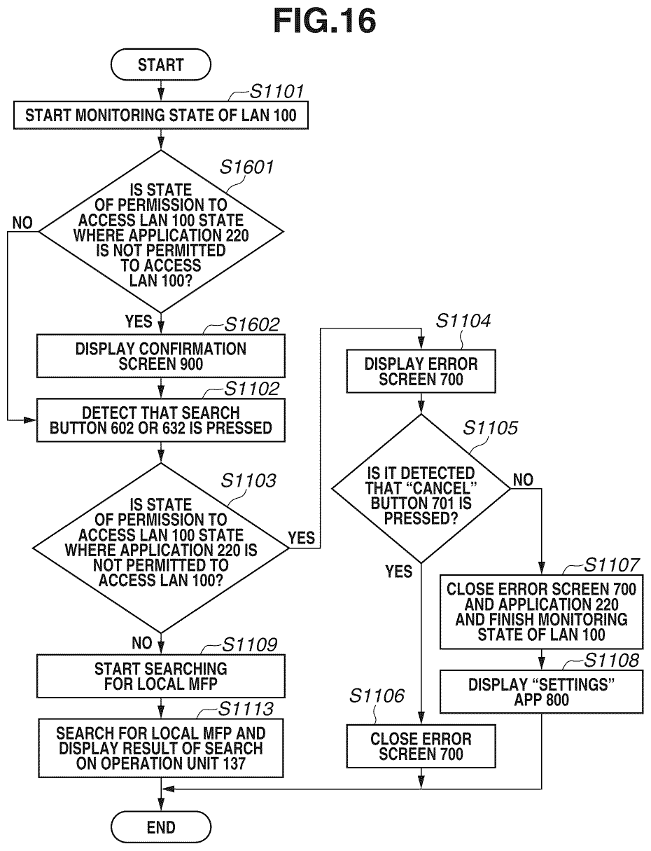

A second exemplary embodiment is described. In the first exemplary embodiment, a description has been given of a form in which both the error screen 700 and the confirmation screen 900 are displayed after the pressing of the search button 602 or 632 for searching for a local MFP is detected. The present disclosure, however, is not limited to this so long as a form is employed in which the user can use the application 220 without permitting the application 220 to access the LAN 100. In the second exemplary embodiment, a description is given of a screen display control sequence in a case where the confirmation screen 900 is displayed when the application 220 starts. A flowchart illustrated in FIG. 16 is a flowchart illustrating a sequence after the application 220 starts. For example, this flowchart is started immediately after the user selects an icon corresponding to the application 220 on a home screen of the information processing apparatus 103.

In step S1101, the application 220 starts monitoring the state of the LAN 100 using the LAN information management module 222. At the timing when step S1101 starts, if the OS 210 determines that the state of permission to access the LAN 100 is the state where the application 220 has not yet been permitted to access the LAN 100 (YES in step S1601), then in step S1602, the OS 210 displays the confirmation screen 900. If the “not permit” button 901 or the “OK” button 902 is pressed on the confirmation screen 900, the OS 210 closes the confirmation screen 900. At the timing when step S1101 starts, if the OS 210 determines that the state of permission to access the LAN 100 is not the state where the application 220 has not yet been permitted to access the LAN 100 (NO in step S1601), the OS 210 does not display the confirmation screen 900.

Next, in step S1102, the application 220 detects that the search button 602 on the initial screen 600 or the search button 632 on the “register/switch” screen 630 is pressed. In step S1103, using the result of monitoring the state of the LAN 100, the LAN information management module 222 of the application 220 determines whether the state of permission to access the LAN 100 is the state where the application 220 is not permitted to access the LAN 100. If it is determined that the state of permission to access the LAN 100 is the state where the application 220 is not permitted to access the LAN 100 (YES in step S1103), then in step S1104, the application 220 displays the error screen 700.

If it is detected that the “cancel” button 701 is pressed on the error screen 700 (YES in step S1105), then in step S1106, the application 220 closes the error screen 700, and this processing sequence ends. If it is detected that the “settings” button 702 is pressed on the error screen 700 (NO in step S1105), then in step S1107, the application 220 closes the error screen 700 and the screen of the application 220 and finishes monitoring the state of the LAN 100. In step S1108, the “settings” app 800 is displayed. If the application 220 detects that the application 220 is displayed on the operation unit 137 again, the application 220 resumes this processing sequence from step S1101 in the flowchart illustrated in FIG. 16.

If it is determined that the state of permission to access the LAN 100 is not the state where the application 220 is not permitted to access the LAN 100 (NO in step S1103), then in step S1109, the application 220 starts searching for a local MFP using the local MFP search module 302. Next, in step S1113, the application 220 displays the result of the search on the operation unit 137, and this processing sequence ends.

By such a processing sequence, it is possible to limit the display of the error screen 700 to a case where it is necessary to communicate via the LAN 100. If it is not necessary to search for a local MFP, it is possible to end this processing sequence by pressing the “cancel” button 701 included in the error screen 700. Thus, it is possible to use the application 220 to confirm another function that uses a cloud MFP or a manual on the “list of functions” screen 620 illustrated in FIG. 6C without permitting the application 220 to access the LAN 100. This improves convenience for the user. In a case where the confirmation screen 900 is displayed in step S1602, no matter which of the “not permit” button 901 and the “OK” button 902 the user selects, the application 220 displays a screen to be displayed after the application 220 starts (e.g., the initial screen 600). Thus, even if the user selects the “not permit” button 901 on the confirmation screen 900 after the application 220 starts, it is possible to select a function of the application 220 that does not use the LAN 100 on an initial screen, and execute the function. A configuration may be employed in which the confirmation screen 900 is displayed only when the application 220 starts for the first time, or a configuration may be employed in which the confirmation screen 900 is displayed every time the application 220 starts.

### Other Exemplary Embodiments

A storage medium recording a program code of software for achieving the above functions may be supplied to a system or an apparatus, and a computer (a CPU or a microprocessor unit (MPU)) of the system or the apparatus may read and execute the program code stored in the storage medium. In this case, the program code itself read from the storage medium achieves the functions of the above exemplary embodiments, and the storage medium storing the program code constitutes the above apparatus.

As the storage medium for supplying the program code, for example, a flexible disk, a hard disk, an optical disc, a magneto-optical disc, a Compact Disc Read-Only Memory (CD-ROM), a Compact Disc-Recordable (CD-R), a magnetic tape, a non-volatile memory card, a ROM, or a Digital Versatile Disc (DVD) can be used.

Not only may the above functions be achieved by executing the program code read by the computer, but also the above functions may be achieved by an OS, while operating on the computer, performing a part or all of actual processing based on an instruction from the program code. OS is the abbreviation of operating system.

Further, the program code read from the storage medium may be written to a memory included in a function extension board inserted into the computer or a function extension unit connected to the computer.

Then, a CPU included in the function extension board or the function extension unit may perform a part or all of actual processing based on an instruction from the program code, thereby achieving the above functions.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-188313, filed Nov. 2, 2023, which is hereby incorporated by reference herein in its entirety.

What is claimed is:

1. A method for an information processing apparatus that executes an application, the method comprising:
receiving selection of a function to be executed from among functions provided by the application from a user; and
in a case where the selection of the function is received in a state where the application is not permitted to use a local area network (LAN), and in a case where the selected function is a function that uses the LAN, displaying a screen regarding permission to use the LAN.

2. The method according to claim 1, wherein the screen is displayed based on a state where the selected function is a function that uses the LAN.

3. The method according to claim 1, wherein in a case where the selected function is a function that does not use the LAN, control is performed not to display the screen.

4. The method according to claim 1, wherein the function that uses the LAN is a function of searching for an external apparatus via the LAN.

5. The method according to claim 1, wherein the function that uses the LAN is a function of transmitting data to an external apparatus via the LAN.

6. The method according to claim 3, wherein the function that does not use the LAN is a function of transmitting data to an external apparatus via a cloud.

7. The method according to claim 1, wherein the application is an application that transmits a print job to a printing apparatus.

8. The method according to claim 1, wherein the screen includes a display item for permitting the application to use the LAN.

9. The method according to claim 1, wherein the screen is a screen for making a setting for permitting the application to use the LAN and includes a display item for transitioning to a settings screen of an operating system (OS).

10. The method according to claim 9, wherein the state where the application is not permitted to use the LAN is a state where a display item for permitting the application to use the LAN is disabled on the settings screen of the OS.

11. The method according to claim 1, wherein the screen displays a display item for not permitting the application to use the LAN, and the state where the application is not permitted to use the LAN is a state where the item for not permitting the application to use the LAN has been selected by the user.

12. The method according to claim 1, wherein the state where the application is not permitted to use the LAN includes a state where the application is not permitted to use the LAN and a state where the application has not yet been permitted to use the LAN.

13. An information processing apparatus that executes application, the information processing apparatus comprising:
at least one memory storing instructions; and
at least one processor that executes the stored instructions, which cause the at least one processor to:
receive selection of a function to be executed from among functions provided by the application from a user; and
in a case where the selection of the function is received in a state where the application is not permitted to use a local area network (LAN), and in a case where the selected function is a function that uses the LAN, display a screen regarding permission to use the LAN.

14. A non-transitory computer-readable storage medium that stores one or more programs including instructions, which when executed by one or more processors of an information processing apparatus that executes an application, cause the information processing apparatus to perform a control method, the control method comprising:
receiving selection of a function to be executed from among functions provided by the application from a user; and
in a case where the selection of the function is received in a state where the application is not permitted to use a local area network (LAN), and in a case where the selected function is a function that uses the LAN, displaying a screen regarding permission to use the LAN.
